(19) United States
(12) Patent Application Publication
(10) Pub. No.: US 2026/0234381 A1
(43) Pub. Date: Aug. 13, 2026

(54) POLYETHYLENE BLEND FOR A FILM LAYER

(71) Applicant: Borealis GmbH, Vienna (AT)

(72) Inventors: Jingbo WANG, Linz (AT); Friedrich BERGER, Linz (AT); Juulia HIRVONEN, Kulloo (FI)

(21) Appl. No.: 19/156,383

(22) PCT Filed: Feb. 6, 2024
(86) PCT No.: PCT/EP2024/052885

§ 371 Date: Aug. 13, 2025

(30) Foreign Application Priority Data
Feb. 14, 2023 (EP) 23156592.0

(51) Int. Cl. C08L 23/0807; B65D 65/40; C08J 5/18

(52) U.S. Cl. CPC C08L 23/0815; C08J 5/18; B65D 65/40; C08J 2323/08; C08J 2423/06; C08L 2203/16; C08L 2205/025; C08L 2207/062; C08L 2207/066; C08L 2314/06

(57) ABSTRACT

Polyethylene blend of a specific multimodal metallocene catalysed linear low density polyethylene (mLLDPE) and a specific high density polyethylene, produced in the presence of a Ziegler-Natta catalyst (znHDPE), which provides films with well-balanced properties, especially stiffness/impact balance.

The present invention relates to a polyethylene blend of a specific multimodal metallocene catalysed linear low density polyethylene (mLLDPE) and a specific high density polyethylene, produced in the presence of a Ziegler-Natta catalyst (ZN-HDPE), which provides films with well-balanced properties, especially stiffness/impact balance.

High standards are nowadays required for packaging materials. Quite often properties are required in the packaging industry, which are conflicting. Typically, high stiffness and toughness are required in parallel, as this leads to less material needed for producing the final product. To achieve these different properties seldom pure components, but rather combinations of different polymer components are used. Two different approaches mainly are at the skilled person's disposal: (a) blends of two or more polymers to form a heterophasic structure, or (b) producing a multilayer structure with different materials providing different functions. Both of them are applied in industry.

Due to the different requirements nowadays multilayer packaging with different type of materials are used, which from one side serve the needs, but from the other side such structures make recycling difficult. Therefore using pure materials is preferred, i.e. a packaging with ‘mono-materials’, i.e. only polyethylene based polymers, is really appreciated. However, this imposes higher requirement to the performance of materials themselves, a material with balanced performance is therefore highly appreciated.

mLLDPE attracts specific interests due to its excellence balance between cost and performance. The main drawback is that the processability and optics are rather poor. One common way is to blend the mLLDPE with LDPE, however, this is known to worsen other properties, like impact.

Multimodal mLLDPEs and znHDPEs as such are known in the state of the art.

For example WO 2022/018239 A1 describes a multimodal ethylene copolymer produced in a two-sage polymerization process, the use of the copolymer in film applications and to a film comprising the copolymer of the invention.

WO 2019/229209 A1 employs at least a three stage polymerization process, optionally preceded by a prepolymerization step, leading to the production of polymers, specifically high density polyethylene homopolymers, which have an improved balance of processability and mechanical properties, such as ESCR and stiffness, which are used for producing caps and closures.

Also mixtures of 2 different polyethylenes for making blown films are described in the literature.

WO 94/25523 A1 for example describes an ethylene polymer composition, comprising from 10 percent (by weight of the total composition) to 95 percent (by weight of the total composition) of:
(A) at least one homogeneously branched substantially linear ethylene/α-olefin interpolymer having:
   (i) a density from 0.88 g/cm³ to 0.935 g/cm³,
   (ii) a molecular weight distribution (Mw/Mn) from 1.8 to 2.8, (iii) a melt index (12) from 0.001 grams/10 minutes (g/10 min) to 10 g/10 min; and
(B) from 5 percent (by weight of the total composition) to 90 percent (by weight of the total composition) of at least one heterogeneously branched ethylene polymer having a density from 0.91 g/cm³ to 0.965 g/cm³.

According to the experimental part the ethylene-1-octene copolymers made by solution polymerization are used.

As stated above the recycling of packaging material after their first use is an important topic nowadays. It is much more challenging to recycle packaging films made of different materials, e.g. different plastics, than to recycle mono-material solutions. On the other hand, the use of different materials is sometimes necessary to obtain acceptable properties, like mechanical properties.

Therefore, an objective of the present invention is the provision of a polyethylene based mono-material solution, which provides an improved mechanical properties, especially dart drop (impact strength) and an improved balance of stiffness and toughness.

The present inventors have found that a blend of a specific multimodal metallocene catalysed linear low density polyethylene (mLLDPE) and a specific high density polyethylene, produced in the presence of a Ziegler-Natta catalyst (ZN-HDPE), provides films with improved mechanical properties, especially dart drop (impact strength) and an improved balance of stiffness and toughness.

### SUMMARY OF INVENTION

The present invention is therefore directed to a polyethylene blend comprising
a) 55.0 wt % to 99.0 wt %, based on the total weight of the polyethylene blend, of a multimodal metallocene catalysed linear low density polyethylene (mLLDPE) which consists of an in-situ blend of
   (i) 30.0 to 70.0 wt % of an ethylene-1-butene polymer component (A), and
   (ii) 70.0 to 30.0 wt % of an ethylene-1-hexene polymer component (B),
whereby the ethylene-1-butene polymer component (A) has
   a density (ISO 1183) in the range of 925 to 965 kg/m³,
   a MFR₂ (190° C., 2.16 kg, ISO 1133) in the range of 1.0 to 400.0 g/10 min;
the ethylene-1-hexene polymer component (B) has
   a density (ISO 1183) in the range of 880 to 915 kg/m³,
   a MFR₂ (190° C., 2.16 kg, ISO 1133) in the range of 0.001 to 1.0 g/10 min;
whereby the multimodal metallocene catalysed linear low density polyethylene (mLLDPE) has
   a density (ISO 1183) in the range of 910 to 925 kg/m³,
   a MFR₂ (190° C., 2.16 kg, ISO 1133) in the range of 0.1 to 5.0 g/10 min, and
b) 1.0 to 45.0 wt %, based on the total weight of the polyethylene blend, of an unimodal high density polyethylene, produced in the presence of a Ziegler-Natta catalyst (znHDPE), whereby said znHDPE has
   a density in the range of 950 to 975 kg/m³,
   a MFR₂ (190° C., 2.16 kg, ISO 1133) in the range of 0.1 to 2.0 g/10 min, and
   a ratio of MFR₂₁ (190° C., 21.6 kg, ISO 1133) to MFR₂ (190° C., 2.16 kg, ISO 1133),
   MFR₂₁/MFR₂, in the range of from 20 to 50.

In an embodiment of the present invention, the ethylene-1-butene polymer component (A) of the multimodal metallocene catalysed linear low density polyethylene (mLLDPE) consists of an ethylene polymer fraction (A-1) and an ethylene polymer fraction (A-2).

Unexpectedly the above defined blend of the invention provides improved dart drop (impact strength) and an improved balance of stiffness and toughness to films comprising such blends.

The invention is therefore further direct to films comprising the above defined polyethylene blend.

### Definitions

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

For the purpose of the present invention the term “consists of an in-situ blend of (i) and (ii)”, does not exclude the presence of any additive, which may be added to the mLLDPE. It only refers to the number of polymer components, i.e. polymer component (A) and polymer component (B).

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

Metallocene catalysed linear low density polyethylene (mLLDPE) is defined in this invention as linear low density polyethylene copolymer, which has been produced in the presence of a metallocene catalyst.

Ziegler-Natta catalysed high density polyethylene (znHDPE) is defined in this invention as high density polyethylene, which has been produced in the presence of a Ziegler-Natta catalyst.

Polyethylene polymers made using single site catalysis, as opposed to Ziegler Natta catalysis, have characteristic features that allow them to be distinguished from Ziegler Natta materials.

In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

For the purpose of the present invention “metallocene catalysed linear low density polyethylene (mLLDPE) which consists of an in-situ blend of an ethylene-1-butene polymer component (A) and an ethylene-1-hexene polymer component (B)” means that the mLLDPE is produced in an at least 2-stage sequential polymerization process, wherein first component (A) is produced and component (B) is then produced in the presence of component (A) in a subsequent polymerization step, yielding the mLLDPE or vice versa, i.e. first component (B) is produced and component (A) is then produced in the presence of component (B) in a subsequent polymerization step, yielding the mLLDPE.

Term “multimodal” in context of multimodal metallocene catalysed linear low density polyethylene means herein multimodality with respect to melt flow rate (MFR) of at least the ethylene polymer components (A) and (B), i.e. the ethylene polymer components (A) and (B), have different MFR values. The multimodal metallocene catalysed linear low density polyethylene can have further multimodality between the ethylene polymer components (A) and (B) with respect to one or more further properties, like density, comonomer type and/or comonomer content, as will be described later below.

### DETAILED DESCRIPTION OF INVENTION

The polyethylene blend according to the present invention comprises a) a multimodal metallocene catalysed linear low density polyethylene (mLLDPE) and b) an unimodal high density polyethylene, which has been produced in the presence of a Ziegler-Natta catalyst (znHDPE).

Thus the blend comprises
a) 55.0 wt % to 99.0 wt %, preferably 65.0 wt % to 96.0 wt %, more preferably 75.0 wt % to 94.0 wt % and even more preferably 78.0 wt % to 92.0 wt %, based on the total weight of the polyethylene blend, of the multimodal metallocene catalysed linear low density polyethylene (mLLDPE) and
b) 1.0 to 45.0 wt %, preferably 4.0 wt % to 35.0 wt %, more preferably 6.0 wt % to 25.0 wt % and even more preferably 8.0 wt % to 22.0 wt %, based on the total weight of the polyethylene blend, of the unimodal high density polyethylene (znHDPE).

In an embodiment the blend consists of a) and b) only, thus the total amounts of a)+b) summing up to 100 wt %.

Ad Multimodal Metallocene Catalysed Linear Low Density Polyethylene (mLLDPE)

The multimodal metallocene catalysed linear low density polyethylene (mLLDPE) is referred herein as “multimodal”, since the ethylene-1-butene polymer component (A), optionally including ethylene polymer fractions (A-1) and (A-2), and ethylene-1-hexene polymer component (B) have been produced under different polymerization conditions resulting in different Melt Flow Rates (MFR, e.g. MFR₂). I.e. the multimodal PE is multimodal at least with respect to difference in MFR of the ethylene polymer components (A) and (B).

The multimodal metallocene catalysed linear low density polyethylene (mLLDPE) consists of an in-situ blend of
(i) 30.0 to 70.0 wt % of an ethylene-1-butene polymer component (A), and
(ii) 70.0 to 30.0 wt % of an ethylene-1-hexene polymer component (B).

The amount of (A) and (B) add up to 100.0 wt %.

In an embodiment of the present invention, the ethylene-1-butene polymer component (A) consists of an ethylene polymer fraction (A-1) and (A-2).

It is possible that fraction (A-1) is produced first and then fraction (A-2) is produced in the presence of fraction (A-1) in a subsequent reactor or vice versa, i.e. fraction (A-2) is produced first and then fraction (A-1) is produced in the presence of fraction (A-2) in a subsequent reactor. Preferably fraction (A-1) is produced first.

In case that the ethylene-1-butene polymer component (A) consists of ethylene polymer fractions (A-1) and (A-2), the MFR₂ of the ethylene polymer fractions (A-1) and (A-2) may be different from each other or may be the same.

The ethylene polymer fractions (A-1) and (A-2) may have a MFR₂ (190° C., 2.16 kg, ISO 1133) in the range 1.0 to 400.0 g/10 min, preferably of 10.0 to 300.0 g/10 min, more preferably of 20.0 to 200.0 g/10 min, even more preferably of 30 to 80.0 g/10 min.

The MFR₂ of the ethylene polymer components (A) and (B) are different from each other. The ethylene polymer component (A) has a MFR₂ (190° C., 2.16 kg, ISO 1133) in the range of 1.0 to 400 g/10 min, preferably of 10.0 to 300.0 g/10 min, more preferably of 20.0 to 200.0 g/10 min, even more preferably of 30 to 80.0 g/10 min.

The ethylene polymer component (B) has a MFR₂ (190° C., 2.16 kg, ISO 1133) in the range of 0.001 to 1.0 g/10 min, preferably of 0.005 to 0.5 g/10 min, more preferably of 0.008 to 0.3 g/10 min and even more preferably of 0.01 to 0.1 g/10 min.

The MFR₂ (190° C., 2.16 kg, ISO 1133) of the multimodal metallocene catalysed linear low density polyethylene (mLLDPE) is in the range of 0.1 to 5.0 g/10 min, preferably 0.2 to 2.5 g/10 min, more preferably 0.3 to 2.0 g/10 min and even more preferably 0.4 to 1.5.

The multimodal metallocene catalysed linear low density polyethylene (mLLDPE) has a ratio of MFR₂₁ (190° C., 21.6 kg, ISO 1133) to MFR₂ (190° C., 2.16 kg, ISO 1133), MFR₂₁/MFR₂, in the range of 30 to 60, preferably 32 to 55, more preferably 35 to 52 and even more preferably 38 to 50.

Naturally, in addition to multimodality with respect to, i.e. difference between, the MFR₂ of ethylene polymer components (A) and (B), the multimodal metallocene catalysed linear low density polyethylene (mLLDPE) of the invention can also be multimodal e.g. with respect to one or both of the two further properties:
multimodality with respect to, i.e. difference between,
   the comonomer content(s) present in the ethylene polymer components (A) and (B); and/or
   the density of the ethylene polymer components (A) and (B).

Preferably, the multimodal metallocene catalysed linear low density polyethylene (mLLDPE) is further multimodal with respect to the comonomer content of the ethylene polymer components (A) and (B).

The comonomer type for the polymer fractions (A-1) and (A-2) is the same, thus both fractions therefore have 1-butene as comonomer.

The comonomer content of component (A) and (B) can be measured, or, in case, and preferably, one of the components is produced first and the other thereafter in the presence of the first produced in so called multistage process, then the comonomer content of the first produced component, e.g. component (A), can be measured and the comonomer content of the other component, e.g. component (B), can be calculated according to following formula: Comonomer content (mol %) in component B=(comonomer content (mol %) in final product-(weight fraction of component A * comonomer content (mol %) in component A))/(weight fraction of component B) Even more preferably the multimodal metallocene catalysed linear low density polyethylene (mLLDPE) of the invention is further multimodal with respect to difference in density between the ethylene polymer component (A) and ethylene polymer component (B). Preferably, the density of ethylene polymer component (A) is different, preferably higher, than the density of the ethylene polymer component (B).

The density of the ethylene polymer component (A) is in the range of 925 to 965 kg/m³, preferably of 935 to 955 kg/m³, more preferably of 938 to 950 kg/m³ and/or the density of the ethylene polymer component (B) is of in the range of 880 to 915 kg/m³, preferably of 882 to 908 kg/m³ and more preferably of 885 to 905 kg/m³.

The polymer fractions (A-1) and (A-2) may have a density in the range of 925 to 965 kg/m³, preferably of 928 to 955 kg/m³, more preferably of 930 to 950 kg/m³, and most preferred 935 to 945 kg/m³.

The density of polymer fraction (A-1) and (A-2) may be the same or may be different from each other.

The density of the multimodal metallocene catalysed linear low density polyethylene (mLLDPE) is in the range of 910 to 925 kg/m³, preferably of 912 to 922 kg/m³ and more preferably of 914 to 920 kg/m³.

More preferably the multimodal metallocene catalysed linear low density polyethylene (mLLDPE) is multimodal at least with respect to, i.e. has a difference between, the MFR₂, the comonomer content as well as with respect to, i.e. has a difference between the density of the ethylene polymer components, (A) and (B), as defined above, below or in the claims including any of the preferable ranges or embodiments of the polymer composition.

It is within the scope of the invention, that, if component (A) consists of two fractions, the first and the second ethylene polymer fraction (A-1 and A-2) of the ethylene polymer component (A) are present in a weight ratio of 4:1 up to 1:4, such as 3:1 to 1:3, or 2:1 to 1:2, or 1:1.

The ethylene polymer component (A) is present in an amount of 30.0 to 70.0 wt % based on the multimodal metallocene catalysed linear low density polyethylene (mLLDPE), preferably in an amount of 32.0 to 55.0 wt % and even more preferably in an amount of 34.0 to 45.0 wt %. Thus, the ethylene polymer component (B) is present in an amount of 70.0 to 30.0 wt % based on the multimodal metallocene catalysed linear low density polyethylene (mLLDPE), preferably in an amount of 68.0 to 45.0 wt % and more preferably in an amount of 66.0 to 55.0 wt %.

The multimodal metallocene catalysed linear low density polyethylene (mLLDPE), can be produced in a 2-stage process, preferably comprising a slurry reactor (loop reactor), whereby the slurry (loop) reactor is connected in series to a gas phase reactor (GPR), whereby either ethylene component (A) or ethylene component (B) is produced in the loop reactor and the other ethylene polymer component is then produced in GPR in the presence of the first produced ethylene polymer component to produce the multimodal metallocene catalysed linear low density polyethylene (mLLDPE), preferably the ethylene polymer component (A) is produced in the loop reactor and the ethylene polymer component (B) is produced in GPR in the presence of the ethylene polymer component (A) to produce the multimodal metallocene catalysed linear low density polyethylene (mLLDPE).

In case that the ethylene component (A) of the multimodal metallocene catalysed linear low density polyethylene (mLLDPE) consists of ethylene polymer fractions (A-1) and (A-2), the multimodal metallocene catalysed linear low density polyethylene (mLLDPE) can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). It is possible that fraction (A-1) is produced first and then fraction (A-2) is produced in the presence of fraction (A-1) in a subsequent reactor or vice versa, i.e. fraction (A-2) is produced first and then fraction (A-1) is produced in the presence of fraction (A-2) in a subsequent reactor. Preferably fraction (A-1) is produced first.

The second loop reactor is thereby connected in series to a gas phase reactor (GPR), so that the first ethylene polymer component (A) leaving the second slurry reactor is fed to the GPR to produce a multimodal polyethylene copolymer.

Such a process is described inter alia in WO 2016/198273, WO 2021009189, WO 2021009190, WO 2021009191 and WO 2021009192. Full details of how to prepare suitable multimodal metallocene catalysed linear low density polyethylene (mLLDPE) can be found in these references.

A suitable process is the Borstar PE process or the Borstar PE 3G process.

The multimodal metallocene catalysed linear low density polyethylene (mLLDPE) according to the present invention is therefore preferably produced in a loop loop gas cascade. Such polymerization steps may be preceded by a prepolymerization step. The purpose of the prepolymerization is to polymerize a small amount of polymer onto the catalyst at a low temperature and/or a low monomer concentration. By prepolymerization it is possible to improve the performance of the catalyst in slurry and/or modify the properties of the final polymer. The prepolymerization step is preferably conducted in slurry and the amount of polymer produced in an optional prepolymerization step is counted to the amount (wt %) of ethylene polymer component (A).

The catalyst components are preferably all introduced to the prepolymerization step when a prepolymerization step is present. However, where the solid catalyst component and the cocatalyst can be fed separately it is possible that only a part of the cocatalyst is introduced into the prepolymerization stage and the remaining part into subsequent polymerization stages. Also in such cases it is necessary to introduce so much cocatalyst into the prepolymerization stage that a sufficient polymerization reaction is obtained therein.

It is understood within the scope of the invention, that the amount or polymer produced in the prepolymerization lies within 1 to 5 wt % in respect to the final metallocene catalysed multimodal metallocene catalysed linear low density polyethylene (mLLDPE). This can counted as part of the first ethylene polymer component (A).

### Catalyst

The multimodal metallocene catalysed linear low density polyethylene (mLLDPE) used in the process of the invention is one made using a metallocene catalyst. A metallocene catalyst comprises a metallocene complex and a cocatalyst. The metallocene compound or complex is referred herein also as organometallic compound (C).

The organometallic compound (C) comprises a transition metal (M) of Group 3 to 10 of the Periodic Table (IUPAC 2007) or of an actinide or lanthanide.

The term “an organometallic compound (C)” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment, the organometallic compound (C) has the following formula (I):

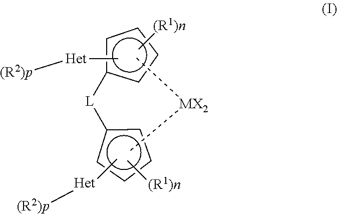

wherein each X is independently a halogen atom, a C₁₋₆-alkyl group, C₁₋₆-alkoxy group, phenyl or benzyl group;
each Het is independently a monocyclic heteroaromatic group containing at least one heteroatom selected from O or S;
L is -R′₂Si—, wherein each R′ is independently C₁₋₂₀-hydrocarbyl or C₁₋₁₀-alkyl substituted with alkoxy having 1 to 10 carbon atoms; M is Ti, Zr or Hf;
each R¹ is the same or different and is a C₁₋₆-alkyl group or C₁₋₆-alkoxy group; each n is 1 to 2;
each R² is the same or different and is a C₁₋₆-alkyl group, C₁₋₆-alkoxy group or —Si(R)₃ group; each R is C₁₋₁₀-alkyl or phenyl group optionally substituted by 1 to 3 C₁₋₆-alkyl groups; and each p is 0 to 1.

Preferably, the compound of formula (I) has the structure

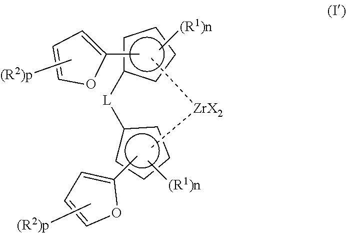

wherein each X is independently a halogen atom, a C₁₋₆-alkyl group, C₁₋₆-alkoxy group, phenyl or benzyl group;
L is a Me₂Si—;
each R¹ is the same or different and is a C₁₋₆-alkyl group, e.g. methyl or t-Bu; each n is 1 to 2;
R² is a —Si(R)₃ alkyl group; each p is 1;
each R is C₁₋₆-alkyl or phenyl group.

Highly preferred complexes of formula (I) are

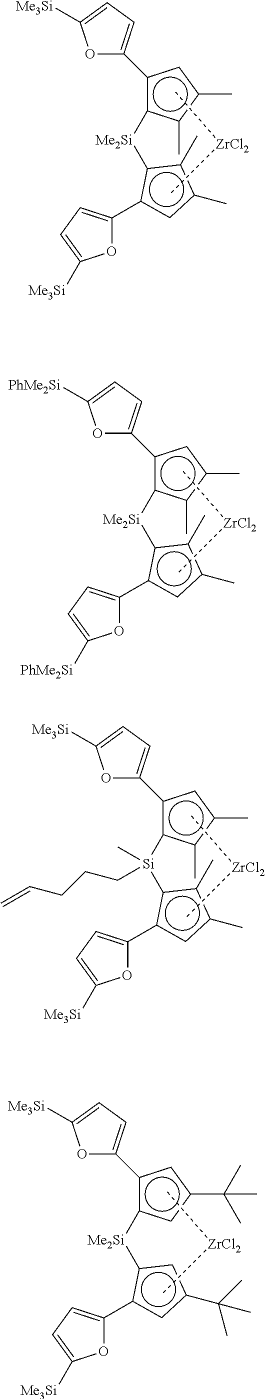

Most preferably the complex dimethylsilanediylbis[2-(5-trimethylsilylfuran-2-yl)-4,5-dimethylcyclopentadien-1-yl]zirconium dichloride is used.

More preferably the ethylene polymer components (A) and (B) of the multimodal metallocene catalysed linear low density polyethylene (mLLDPE) are produced using, i.e. in the presence of, the same metallocene catalyst.

To form a catalyst, a cocatalyst, also known as an activator, is used, as is well known in the art. Cocatalysts comprising A1 or B are well known and can be used here. The use of aluminoxanes (e.g. MAO) or boron based cocatalysts (such as borates) is preferred.

The multimodal metallocene catalysed linear low density polyethylene (mLLDPE) may contain further polymer components and optionally additives and/or fillers. In case the multimodal metallocene catalysed linear low density polyethylene (mLLDPE) contains further polymer components, then the amount of the further polymer component(s) typically varies between 3.0 to 20.0 wt % based on the combined amount of the multimodal metallocene catalysed linear low density polyethylene (mLLDPE) and the other polymer component(s).

The optional additives and fillers and the used amounts thereof are conventional in the field of film applications. Examples of such additives are, among others, antioxidants, process stabilizers, UV-stabilizers, pigments, fillers, antistatic additives, antiblock agents, nucleating agents, acid scavengers as well as polymer processing agent (PPA).

It is understood herein that any of the additives and/or fillers can optionally be added in so-called master batch, which comprises the respective additive(s) together with a carrier polymer. In such case the carrier polymer is not calculated to the polymer components of the multimodal metallocene catalysed linear low density polyethylene (mLLDPE), but to the amount of the respective additive(s), based on the total amount of the multimodal metallocene catalysed linear low density polyethylene (mLLDPE) (100 wt %).

Ad unimodal high density polyethylene (znHDPE) The polyethylene blend according to the present invention comprises as component b) a znHDPE; whereby said znHDPE has a density determined according to ISO 1183 in the range of 950 to 975 kg/m³ and a MFR₂ (190° C., 2.16 kg, ISO 1133) in the range of 0.1 to 2.0 g/10 min.

The MFR₂ (190° C., 2.16 kg, ISO 1133) is preferably in the range of 0.2 to 1.8 g/10 min, more preferably in the range of 0.3 to 1.5 g/10 min, even more preferably in the range of 0.5 to 1.2 g/10 min.

The znHDPE has a melt flow rate MFR₂₁ (190° C., 21.0 kg, ISO 1133) of 10.0 to 60.0 g/10 min, preferably 20.0 to 50.0 g/10 min, more preferably 25.0 to 45.0 g/10 min and even more preferably, 30.0 to 40.0 g/10 min.

The (melt) flow rate ratio FRR_{21/2}(MFR₂₁/MFR₂) of the znHDPE is in the range of 20 to 50, preferably from 25 to 45 and most preferably from 30 to 40.

The density determined according to ISO 1183 of the znHDPE is preferably in the range of 952 to 972 kg/m³, more preferably in the range of 955 to 970 kg/m³ and even more preferably in the range of 958 to 965 kg/m³.

Preferably, the znHDPE is an ethylene homopolymer or an ethylene copolymer. An ethylene copolymer is a polymer which comprises ethylene monomer and one or more comonomer(s).

The comonomer can be an alpha-olefin having 4 to 12 carbon atoms, e.g. 1-butene, 4-methyl-1-pentene, 1-hexene, 1-octene, 1-decene, preferably 1-butene, 1-hexene or 1-octene, most preferably 1-butene.

More preferably, the znHDPE is an ethylene homopolymer,

The znHDPE is a unimodal znHDPE and is produced either in one polymerization stage, preferably in a loop reactor, or in a two-stage polymerization stage, wherein in both stages the same reaction conditions are applied in order to produce the same kind of polymer in both stages.

Preferably the unimodal znHDPE is produced in one polymerization step, more preferably in one loop polymerization step. The polymerization conditions are as described above for the mLLDPE.

As described for the mLLDPE, such polymerization steps may be preceded by a prepolymerization step.

The znHDPE used according to the present invention is produced in the presence of a Ziegler-Natta catalyst.

The polymerization is typically conducted in the presence of a Ziegler-Natta polymerization catalyst. Suitable Ziegler-Natta (ZN) catalysts generally comprise at least a catalyst component formed from a transition metal compound of Group 4 to 6 of the Periodic Table (IUPAC, Nomenclature of Inorganic Chemistry, 1989), a metal compound of Group 1 to 3 of the Periodic Table (IUPAC), optionally a compound of group 13 of the Periodic Table (IUPAC), and optionally an internal organic compound, like an internal electron donor. A ZN catalyst may also comprise further catalyst component(s), such as a cocatalyst and optionally external additives.

Suitable ZN catalysts preferably contain a magnesium compound, an aluminium compound and a titanium compound supported on a particulate support.

The particulate support can be an inorganic oxide support, such as silica, alumina, titania, silica-alumina, silica-titania or a MgCl2 based support. Preferably, the support is silica or a MgCl2 based support.

Particularly preferred Ziegler-Natta catalysts are such as described in EP 1378528 A1.

If used, the magnesium compound preferably is a reaction product of a magnesium dialkyl and an alcohol. The alcohol is a linear or branched aliphatic monoalcohol. Preferably, the alcohol has from 6 to 16 carbon atoms. Branched alcohols are especially preferred, and 2-ethyl-1-hexanol is one example of the preferred alcohols. The magnesium dialkyl may be any compound of magnesium bonding to two alkyl groups, which may be the same or different.

Butyl-octyl magnesium is one example of the preferred magnesium dialkyls.

The aluminium compound is a chlorine containing aluminium alkyl. Especially preferred compounds are aluminium alkyl dichlorides and aluminium alkyl sesquichlorides.

The transition metal compound of Group 4 to 6 is preferably a titanium or vanadium compound, more preferably a halogen containing titanium compound, most preferably chlorine containing titanium compound. An especially preferred titanium compound is titanium tetrachloride.

The catalyst can be prepared by sequentially contacting the carrier with the above mentioned compounds, as described in EP 688794 or WO 99/51646. Alternatively, it can be prepared by first preparing a solution from the components and then contacting the solution with a carrier, as described in WO 01/55230.

Another group of suitable ZN catalysts contain a titanium compound together with a magnesium halide compound acting as a support. Thus, the catalyst contains a titanium compound and optionally a Group 13 compound for example an aluminium compound on a magnesium dihalide, like magnesium dichloride. Such catalysts are disclosed, for instance, in WO 2005/118655, EP 810235, WO 2014/096296 and WO 2016/097193.

Suitable activators are group 13 metal compounds, typically group 13 alkyl compounds and especially aluminium alkyl compounds, where the alkyl group contains 1 to 16 C-atoms. These compounds include trialkyl aluminium compounds, such as trimethylaluminium, triethylaluminium, tri-isobutylaluminium, trihexylaluminium and tri-n-octylaluminium, alkyl aluminium halides, such as ethylaluminium dichloride, diethylaluminium chloride, ethylaluminium sesquichloride, dimethylaluminium chloride and the like. Especially preferred activators are trialkylaluminiums, of which triethylaluminium, trimethylaluminium and tri-isobutylaluminium are particularly used.

The amount in which the activator is used depends on the specific catalyst and activator. Typically triethylaluminium is used in such amount that the molar ratio of aluminium to the transition metal, like Al/Ti, is from 1 to 1000, preferably from 3 to 100 and in particular from about 5 to about 30 mol/mol.

An optional internal organic compound may be chosen from the following classes: ethers, esters, amines, ketones, alcohols, anhydrides or nitriles or mixtures thereof. Preferably, the optional internal organic compound is selected from ethers and esters, most preferably from ethers. Preferred ethers are of 2 to 20 carbon-atoms and especially mono, di or multi cyclic saturated or unsaturated ethers comprising 3 to 6 ring atoms. Typical cyclic ethers suitable in the present invention, if used, are tetrahydrofuran (THF), substituted THF, like 2-methyl THF, di-cyclic ethers, like 2,2-di(2-tetrahydrofuryl)propane, 2,2-di-(2-furan)-propane, or isomers or mixtures thereof. Internal organic compounds are also often called as internal electron donors.

### Polyethylene Blend

The polyethylene blend preferably has a density determined according to ISO 1183 in the range of 915 to 935 kg/m³, more preferably in the range of 918 to 932 kg/m³ and even more preferably in the range of 920 to 930 kg/m³.

The MFR₂ (190° C., 2.16 kg, ISO 1133) of the blend is preferably in the range of 0.3 to 2.0 g/10 min, more preferably in the range of 0.4 to 1.5 g/10 min, and even more preferably in the range of 0.5 to 1.0 g/10 min.

As mentioned above, the polyethylene blend according to the present invention provides improved dart drop (impact strength) and an improved balance of stiffness and toughness to films comprising such blends.

The invention is therefore further direct to films comprising the above defined polyethylene blend.

### Film

The film of the invention comprises at least one layer comprising the above defined polyethylene blend. The film can be a monolayer film comprising the above defined polyethylene blend or a multilayer film, wherein at least one layer comprises the above defined polyethylene blend. The terms “monolayer film” and multilayer film” have well known meanings in the art.

The films are preferably produced by any conventional film extrusion procedure known in the art including cast film and blown film extrusion. Most preferably, the film is a blown or cast film, especially a blown film. E.g. the blown film is produced by extrusion through an annular die and blowing into a tubular film by forming a bubble which is collapsed between nip rollers after solidification. This film can then be slit, cut or converted (e.g. gusseted) as desired.

Conventional film production techniques may be used in this regard. If the preferable blown or cast film is a multilayer film then the various layers are typically coextruded. The skilled man will be aware of suitable extrusion conditions.

Films according to the present invention may be subjected to post-treatment processes, e.g. surface modifications, lamination or orientation processes or the like. Such orientation processes can be mono-axially (MDO) or bi-axially orientation, wherein mono-axial orientation is preferred.

In another preferred embodiment, the films are unoriented.

Preferred films according to the invention are monolayer blown films. The monolayer film of the invention may have a thickness of 20 to 120 μm, preferably 30 to 100 μm and more preferably 35 to 80 μm. Films of the invention are preferably not stretched in the machine or transverse or biaxial direction.

The films of the invention are characterized by a dart-drop impact strength (DDI) determined according to ISO 7765-1 on a 40 μm monolayer test blown film of at least 1300 g up to 2500 g, preferably 1500 g up to 2400 g and more preferably 1700 g up to 2200 g.

Films according to the present invention furthermore have good stiffness (tensile modulus measured on a 40 μm monolayer test blown film according to ISO 527-3), i.e. at least 200 MPa (in both directions).

Thus, the films comprising the above defined polyethylene blend in addition have a tensile modulus (measured on a 40 μm monolayer test blown film according to ISO 527-3) in machine (MD) as well as in transverse (TD) direction in the range of 200 MPa to 700 MPa, preferably of 240 MPa to 550 MPa, more preferably of 250 to 450 MPa.

Films according to the present invention may have a haze measured according to ASTM D1003 on a 40 μm test blown film of below 25%, preferably in the range of 5 to 22% and more preferably in the range of 8 to 19%.

In one embodiment of the present invention, the optomechanical ability (OMA) according to formula (II):

$$OMA = \frac{Tensile Modulus ( MD ) [ MPa ] * DDI [ g ]}{Haze ( 40 μm ) [ \% ]}$$

of 40 μm test blown film is at least 20000 [MPa*g/%] up to 80000 [MPa*g/%], preferably in the range of from 22000 [MPa*g/%] up to 65000 [MPa*g/%], more preferably in the range of from 25000 [MPa*g/%] up to 55000 [MPa*g/%], wherein the Tensile Modulus in machine direction is measured according to ISO 527-3 at 23° C. on 40 μm test blown films, DDI is the dart-drop impact strength determined according to ISO 7765 on a 40 μm test blown film and haze is measured according to ASTM D1003 on a 40 μm test blown film.

In view of the present invention, optomechanicalabilty (OMA) is understood as the ratio of mechanical (especially DDI and tensile (MD)) behaviour, to optical performance, namely haze, wherein the mechanical properties are targeted to be as high as possible and the optical performance in the sense of haze is desired to be as low as possible.

The inventive films are fully recyclable and thus improves sustainability, as it is in the most preferred embodiment a “100% PE” solution with no other polymer than ethylene based polymers being present.

In another embodiment the inventive film contains at least 90 wt % of PE polymers, more preferably 95 to 99 wt % of PE polymers (difference to 100 wt % can be other polymers than PE), and is thus also suitable for being recycled.

The films according to the present invention are highly useful for being used in various packaging applications, wherein applications related to food packaging are preferred.

Furthermore the films according to the present invention may be used as a layer in multilayer polyethylene based blown films, preferably as core layer in multilayer polyethylene based blown films.

The invention will be further described with reference to the following non-limiting examples.

### Determination Methods

Unless otherwise stated in the description or in the experimental part, the following methods were used for the property determinations of the polymers (including its fractions and components) and/or any sample preparations thereof as specified in the text or experimental part.

### Melt Flow Rate

The melt flow rate (MFR) was determined according to ISO 1133 and is indicated in g/10 min. The MFR is an indication of the flowability, and hence the processability, of the polymer. The higher the melt flow rate, the lower the viscosity of the polymer. The MFR is determined at 190° C. for polyethylene. MFR may be determined at different loadings such as 2.16 kg (MFR₂), 5 kg (MFR₅) or 21.6 kg (MFR₂₁).

### Calculation of MFR₂ of Component B and of Fraction (A-2)

$$log A = x \cdot log B + ( 1 - x ) \cdot log C$$

$$C = {10}^{⋀ \frac{( logA - x \cdot logB )}{( 1 - x )}}$$

### For Component B:

B=MFR₂ of Component (A)
C=MFR₂ of Component (B)
A=final MFR₂ of multimodal metallocene catalysed linear low density polyethylene (mLLDPE)
X=weight fraction of Component (A)

### For Fraction (A-2):

B=MFR₂ of 1^{st} fraction (A-1)
C=MFR₂ of 2^{nd} fraction (A-2)
A=final MFR₂ (mixture) of loop polymer (=Component (A))
X=weight fraction of the 1^{st} fraction (A-1)

### Density

Density of the polymer was measured according to ISO 1183-1 and ISO1872-2 for sample preparation.

### Dart Drop Strength (DDI): Impact Resistance by Free-Falling Dart Method

The DDI was measured according to ISO 7765-1:1988/Method A from the films (non-oriented films and laminates) as produced indicated below. This test method covers the determination of the energy that causes films to fail under specified conditions of impact of a free-falling dart from a specified height that would result in failure of 50% of the specimens tested (Staircase method A). A uniform missile mass increment is employed during the test and the missile weight is decreased or increased by the uniform increment after test of each specimen, depending upon the result (failure or no failure) observed for the specimen.

### Standard Conditions:

Conditioning time: >96 h
Test temperature: 23° C.
Dart head material: phenolic
Dart diameter: 38 mm
Drop height: 660 mm

### Results:

Impact failure weight-50% [g]

### Tensile Modulus

Tensile modulus (E-Mod (MPa) was measured in machine and/or transverse direction according to ISO 527-3 on film samples prepared as described under the Film Sample preparation with film thickness of 40 μm and at a cross head speed of 1 mm/min for the modulus.

### Haze

Haze was determined according to ASTM D 1003-00 on film samples prepared as described under the Film Sample preparation with film thickness of 40 μm.

### Film Sample Preparation

The test films consisting of the inventive blend and respective comparative films of 40 μm thickness, were prepared using a Collin blown film line. Film samples were produced with BUR 1:2.5 (melt temperature: 210° C., uptake speed: 7 m/min).

The blends were prepared directly in the line.

### EXAMPLES

### Cat.Example: Catalyst Preparation (CAT1-for mLLDPE)

### Loading of SiO2:

10 kg of silica (PQ Corporation ES757, calcined 600° C.) was added from a feeding drum and inertized in the reactor until O₂ level below 2 ppm was reached.

### Preparation of MAO/Tol/MC:

30 wt % MAO in toluene (14.1 kg) was added into another reactor from a balance followed by toluene (4.0 kg) at 25° C. (oil circulation temperature) and stirring 95 rpm. Stirring speed was increased 95 rpm->200 rpm after toluene addition, stirring time 30 minutes. 477 g of metallocene Rac-dimethylsilanediylbis{2-(5-(trimethylsilyl)furan-2-yl)-4,5-dimethyl-cyclopentadien-1-yl}zirconium dichloride was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst:

Reactor temperature was set to 10° C. (oil circulation temp) and stirring was turned to 40 rpm during MAO/tol/MC addition. MAO/tol/MC solution (22.2 kg) was added within 205 min followed by 60 min stirring time (oil circulation temperature was set to 25° C.). After stirring “dry mixture” was stabilised for 12 h at 25° C. (oil circulation temperature), stirring 0 rpm. Reactor was turned 20° (back and forth) and stirring was turned on 5 rpm for few rounds once an hour. After stabilisation the catalyst was dried at 60° C. (oil circulation temperature) for 2 h under nitrogen flow 2 kg/h, followed by 13 h under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

Polymerization of mLLDPE:

Polymerization was conducted in a Borstar pilot plant with a 3-reactor set-up (loop1-loop2-GPR 1) and a prepolymerization loop reactor. mLLDPE was produced by using the polymerization conditions as given below.

TABLE 1
Polymerization conditions for mLLDPE

| | mLLDPE |
|---|---|
| Prepoly reactor | |
| Catalyst feed (g/h) | 30 |
| Temp. (° C.) | 50 |
| Press. (kPa) | 5624 |
| C2 (kg/h) | 4.0 |
| H2(g/h) | 0.0 |
| C4 (g/h) | 93.5 |
| Split (wt %) | 3.6 |
| loop 1 Fraction (A-1) | |
| Temp. (° C.) | 85 |
| Press. (kPa) | 5534 |
| C2 conc. (mol %) | 4.4 |
| H2/C2 ratio (mol/kmol) | 0.94 |
| C4/C2 ratio (mol/kmol) | 72.7 |
| Split (wt %) | 18.7 |
| Density (kg/m3) of loop 1 material (fraction (A-1)) | 942.6 |
| MFR₂ (g/10 min) of loop 1 material (fraction (A-1)) | 42.0 |
| loop 2 Fraction (A-2) | |
| Temp. (° C.) | 85 |
| Press. (kPa) | 5349 |
| C2 conc. (mol %) | 4.1 |
| H2/C2 ratio (mol/kmol) | 0.60 |
| C4/C2 ratio (mol/kmol) | 50.0 |
| Split (wt %) | 19.8 |
| Density (kg/m³) after loop 2 (component (A)) | 941.2 |
| MFR₂ (g/10 min) after loop 2 (component (A)) | 38.4 |
| MFR₂ (g/10 min) of loop 2 material (fraction (A-2)) | 34.7 |
| Density (kg/m³) of loop 2 material (fraction (A-2)) | 939.6 |
| GPR | |
| Temp. (° C.) | 75 |
| Press. (kPa) | 2000 |
| H2/C2 ratio (mol/kmol) | 0.72 |
| C6/C2 ratio (mol/kmol) | 10.25 |
| Split (wt %) | 57.9 |
| MFR₂ (g/10 min) of GPR material (Component (B)) | 0.03 |
| Density (kg/m³) of GPR material (Component (B)) | 899.0 |

The polymer was mixed with 2400 ppm of Irganox B561 and 270 ppm of Dynamar FX 5922 compounded and extruded under nitrogen atmosphere to pellets by using a JSW extruder so that the SEI was 230 kWh/kg and the melt temperature 25000.

TABLE 2
Material properties of mLLDPE

| Material | mLLDPE |
|---|---|
| MFR₂ (g/10 min) | 0.6 |
| MFR₂₁ (g/10 min) | 23.8 |
| MFR₂₁/MFR₂ | 39.7 |
| Density (kg/m³) | 916.6 |

### HDPE:

HDPE (a) for IE1: a unimodal HDPE produced with Lynx 200 catalyst supplied by Grace Catalysts Technologies in a pilot plant, with a configuration of prepolymerization and loop, it was pelletized with 500 ppm Irganox 1010 (supplied by BASF), 2000 ppm Irgafos 168 (supplied by BASF), 500 ppm Calcium stearate (CEASIT Fl, supplied by Baerlocher) on a twin screw extruder. It has final MFR₂ 0.94 g/10 min, density 961.5 kg/m³. Production details are presented in Table 3 below.

HDPE (b) for CE1: a bimodal HDPE produced with a ZN catalyst (as disclosed in Example 1 in EP 1378528), in a pilot plant, with a configuration of prepolymerization-loop-gas phase reactor, having MFR2 of 1.5 g/10 min, density of 960.7 kg/m3. It was pelletized with 500 ppm Irganox 1010 (supplied by BASF), 2000 ppm Irgafos 168 (supplied by BASF), 500 ppm Calcium stearate (CEASIT Fl, supplied by Baerlocher) on a twin screw extruder. Production details are presented in Table 3 below.

HDPE (c) for CE2: a bimodal HDPE produced with a ZN catalyst (as disclosed in Example 1 in EP 1378528), in a pilot plant, with a configuration of prepolymerization-loop—gas phase reactor, having MFR₂ of 0.7 g/10 min, density of 959.5 kg/m³. It was pelletized on a twin screw extruder with 1000 ppm of Irganox B561 (a 1:4 mixture of Irganox 1010 and Irgafos 168, produced by BASF) and 1000 ppm Calcium stearate (CEASIT Fl, supplied by Baerlocher). Production details are presented in Table 3 below.

TABLE 3
Polymerization conditions for HDPEs

| | HDPE (a) | HDPE (b) | HDPE (c) |
|---|---|---|---|
| Prepoly | | | |
| Catalyst feed (g/h) | 1.0 | 36 | 33 |
| Temp. (° C.) | 60 | 70 | 70 |
| Press. (bar) | 55 | 57 | 64 |
| H2 (g/h) | 5.0 | 5.0 | 2.0 |
| C4 (g/h) | 0 | 80 | 80 |
| Split (wt %) | 3.6 | 1.4 | 1.7 |
| Loop reactor | | | |
| Temp. (° C.) | 95 | 95 | 95 |
| Press. (bar) | 51 | 54 | 64 |
| C2 conc. (mol %) | 4.2 | 4.1 | 2.8 |
| H2/C2 (mol/kmol) | 91.2 | 312 | 456 |
| C4/C2 (mol/kmol) | 0 | 9 | 8 |
| Density (kg/m³) | 960 | 970 | 972 |
| split % | 96.4 | 42.6 | 43.3 |
| MFR₂ (g/10 min) | 0.97 | 214 | 280 |
| GPR | Not used | | |
| Temp. (° C.) | | 85 | 85 |
| Press. (bar) | | 20 | 20 |
| H2/C2 (mol/kmol) | | 142 | 110 |
| C4/C2 (mol/kmol) | | 11 | 18.8 |
| split % | | 56 | 55 |
| Pellet | | | |
| Density (kg/m³) | 961.5 | 960.7 | 959.5 |
| MFR₂ (g/10 min) | 0.94 | 1.5 | 0.7 |
| MFR₂₁ (g/10 min) | 34.0 | 81.7 | 42.0 |
| MFR₂₁/MFR₂ | 36.2 | 54.1 | 60.0 |
| MFR₂ in GPR (g/10 min) | — | 0.03 | 0.005 |
| Density in GPR (kg/m³) | — | 952.3 | 949 |

### Monolayer Blown Films

The above produced mLLDPE was blended with the HDPE directly on the film extrusion line. The following films have been produced with the above described method (film sample preparation).

TABLE 4
Inventive and Comparative Films

| | Unit | CE1 | CE2 | IE1 |
|---|---|---|---|---|
| mLLDPE | wt % | 80 | 80 | 80 |
| HDPE (a) | wt % | — | — | 20 |
| HDPE (b) | wt % | 20 | — | — |
| HDPE (c) | wt % | — | 20 | — |
| Blend properties | | | | |
| Density | kg/m³ | 925 | 925 | 926 |
| MFR₂ | g/10 min | 0.7 | 0.6 | 0.7 |
| Film properties | | | | |
| TM/MD | MPa | 317 | 311 | 299 |
| TM/TD | MPa | 400 | 380 | 343 |
| Haze | % | 18.1 | 20.2 | 17.9 |
| DDI | g | 1008 | 1219 | 1965 |
| OMA | | 17654 | 18768 | 32823 |

The data demonstrates that using the specific mLLDPE, as described above, blended with the specific unimodal HDPE leads to an increased DDI and an improved stiffness/impact and balance. In addition haze is comparable or slightly improved.

1. A polyethylene blend comprising;
a) 55.0 wt % to 99.0 wt %, based on total weight of the polyethylene blend, of a multimodal metallocene catalysed linear low density polyethylene (mLLDPE) which consists of an in-situ blend of:
(i) 30.0 to 70.0 wt % of an ethylene-1-butene polymer component (A); and
(ii) 70.0 to 30.0 wt % of an ethylene-1-hexene polymer component (B);
wherein the ethylene-1-butene polymer component (A) comprises:
a density (ISO 1183) in a range of 925 to 965 kg/m³;
a MFR₂ (190° C., 2.16 kg, ISO 1133) in the range of 1.0 to 400.0 g/10 min;
the ethylene-1-hexene polymer component (B) comprises:
a density (ISO 1183) in a range of 880 to 915 kg/m³;
a MFR₂ (190° C., 2.16 kg, ISO 1133) in a range of 0.001 to 1.0 g/10 min;
wherein the multimodal metallocene catalysed linear low density polyethylene (mLLDPE) comprises:
a density (ISO 1183) in the range of 910 to 925 kg/m³;
a MFR₂ (190° C., 2.16 kg, ISO 1133) in the range of 0.1 to 5.0 g/10 min; and
b) 1.0 to 45.0 wt %, based on the total weight of the polyethylene blend, of an unimodal high density polyethylene, produced in presence of a Ziegler-Natta catalyst (znHDPE), wherein said znHDPE comprises:
a density (ISO 1183) in the range of 950 to 975 kg/m³;
a MFR₂ (190° C., 2.16 kg, ISO 1133) in the range of 0.1 to 2.0 g/10 min; and
a ratio of the MFR₂1 (190° C., 21.6 kg, ISO 1133) to MFR₂ (190° C., 2.16 kg, ISO 1133), MFR₂₁/MFR₂ in a range of 20 to 50.

2. The polyethylene blend according to claim 1, wherein in the multimodal metallocene catalysed linear low density polyethylene (mLLDPE) the ethylene-1-butene polymer component (A) consists of an ethylene polymer fraction (A-1) and an ethylene polymer fraction (A-2),
wherein the density (ISO 1183) of fractions (A-1) and (A-2) is in the range of 925 to 965 kg/m³, and
the MFR₂ (190° C., 2.16 kg, ISO 1133) of fractions (A-1) and (A-2) is in the range of 1.0 to 400.0 g/10 min and
wherein the density and/or the MFR₂ (190° C., 2.16 kg, ISO 1133) of ethylene polymer fractions (A-1) and (A-2) may be the same or may be different.

3. The polyethylene blend according to claim 1, wherein in the multimodal metallocene catalysed linear low density polyethylene (mLLDPE)
the ethylene polymer component (A) comprises a MFR₂ (190° C., 2.16 kg, ISO 1133) in the range of 10.0 to 300.0 g/10 min and/or
the ethylene polymer component (B) comprises a MFR₂ (190° C., 2.16 kg, ISO 1133) in the range of 0.005 to 0.5 g/10 min.

4. The polyethylene blend according to claim 1, wherein in the multimodal metallocene catalysed linear low density polyethylene (mLLDPE) the ratio of the MFR₂1 (190° C., 21.6 kg, ISO 1133) to MFR₂ (190° C., 2.16 kg, ISO 1133), MFR₂₁/MFR₂ is in the range of 30 to 60.

5. The polyethylene blend according to claim 1, wherein the multimodal metallocene catalysed linear low density polyethylene (mLLDPE) is produced in the presence of a metallocene complex of formula (I): 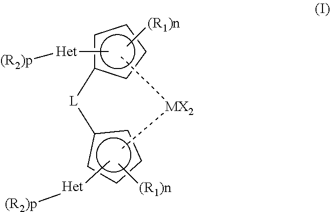
wherein each X is independently a halogen atom, a C₁₋₆-alkyl group, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having-comprising 1 to 10 carbon atoms;
M is Ti, Zr or Hf;
each R₁ is the same or different and is a C₁₋₆-alkyl group or C₁₋₆-alkoxy group;
each n is 1 to 2;
each R₂ is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

6. The polyethylene blend according to claim 1, wherein the znHDPE comprises a MFR₂ (190° C., 2.16 kg, ISO 1133) in the range of 0.2 to 1.8 g/10 min, and
a density (ISO 1183) in the range of 952 to 972 kg/m³.

7. The polyethylene blend according to claim 1, wherein the znHDPE comprises a MFR₂1 (190° C., 21.0 kg, ISO 1133) of 10.0 to 60.0 g/10 min, and/or a melt flow rate ratio MFR₂₁/MFR₂ from 25 to 45.

8. The polyethylene blend according to claim 1, wherein the znHDPE is an ethylene homopolymer.

9. The polyethylene blend according to claim 1, wherein the blend consists of:
a) 65.0 wt % to 96.0 wt %, based on the total weight of the polyethylene blend, of the multimodal metallocene catalysed linear low density polyethylene (mLLDPE); and
b) 4.0 wt % to 35.0 wt % based on the total weight of the polyethylene blend, of the high density polyethylene (znHDPE), the total amounts of a)+b) summing up to 100 wt %.

10. The polyethylene blend according to claim 1, wherein the blend comprises a density (ISO 1183) in the range of 915 to 935 kg/m³, and
a MFR₂ (190° C., 2.16 kg, ISO 1133) in the range of 0.3 to 2.0 g/10 min.

11. Use of the polyethylene blend according to claim 1 for preparation of a monolayer blown film.

12. A monolayer blown film, comprising a polyethylene blend according to claim 1, wherein the film comprises a dart-drop impact strength (DDI) determined according to ISO 7765-1, method A on a 40 m monolayer test blown film of at least 1300 g up to 2500 g.

13. The monolayer blown film according to claim 12, wherein the film comprises a tensile modulus (measured on a 40 μm monolayer test blown film according to ISO 527-3) in machine (MD) as well as in transverse (TD) direction in a range of 200 MPa to 700 MPa.

14. The monolayer blown film according to claim 12, wherein the film comprises an optomechanical ability (OMA) according to formula (II):
$$OMA = \frac{Tensile Modulus ( MD ) [ MPa ] * DDI [ g ]}{Haze ( 40 μm ) [ \% ]} \qquad ( II )$$
of at least 20000 [MPa*g/%] up to 80000 [MPa*g/%], wherein the Tensile Modulus in machine direction is measured according to ISO 527-3 at 23° C. on 40 μm test blown films, DDI is the dart-drop impact strength determined according to ISO 7765-1 on a 40 μm test blown film and haze is measured according to ASTM D1003 on a 40 m test blown film.

15. Use of a film according to claim 12 as packaging material, in particular as a packaging material for food or as a layer in multilayer polyethylene based blown films.
